(19) United States
(12) Patent Application Publication
(10) Pub. No.: US 2015/0324776 A1
(43) Pub. Date: Nov. 12, 2015

(54) Invoice Issuing System and Invoice Issuing Method

(71) Applicant: Nippon Gas Co., Ltd., Tokyo (JP)

(72) Inventors: Shinji Wada, Tokyo (JP); Shingo Dekamo, Tokyo (JP)

(21) Appl. No.: 14/410,853

(22) PCT Filed: Jul. 2, 2013
(86) PCT No.: PCT/JP2013/004111

§ 371 Date: Dec. 23, 2014

(30) Foreign Application Priority Data
Jul. 4, 2012 (JP) 2012-150732

(51) Int. Cl. G06Q 20/14; G06Q 50/06

(52) U.S. Cl. CPC G06Q 20/145; G06Q 50/06

(57) ABSTRACT

A delivery server includes: a receiving unit for receiving, from a mobile terminal, a request for a reading process of a gas meter as a meter target; a calculation unit for performing a meter reading process according to the request to calculate the gas fee for a customer in the current meter reading month; a payment situation check unit for checking, from the payment situation of the storage unit, the gas fee payment situation for the customer prior to the current meter reading month based on the request, and reading the unpaid gas fee from the management unit, when the gas fee is unpaid; an issuing unit for issuing invoice information including the gas fee in the current meter reading month and the unpaid gas fee; and a transmission unit for transmitting the invoice information to the mobile terminal.

### TECHNICAL FIELD

The present invention relates to a system and a method for invoicing a gas fee.

### BACKGROUND ART

It is known that LP gas is supplied by gas imported from gas-producing countries and gas as a byproduct of domestic process of petroleum oil products. An import base for storing LP gas transferred from gas-producing countries by a tanker and a petroleum oil purification base are referred to as a primary base. LP gas is loaded from the primary base to domestic vessels or tank trucks and is shipped to a secondary base that is located at a coast or an inland and that functions as a supply base for LP gas transportation. The LP gas transported to the secondary base is transported to an LP gas filling station at each location (i.e., a delivery base) and is filled into a gas cylinder (gas bottle) at a delivery base.

The gas cylinders filled at the respective filling stations are delivered by a deliveryman to a customer's home (e.g., a standard home, collective housing, or office). An empty gas cylinder of the customer's home is exchanged with a filled gas cylinder and the empty gas cylinder is collected to a filling station. Each filling station has a fixed delivery area for which a deliveryman is responsible. A deliveryman receives delivery slips corresponding to 2 to 10 days showing delivery destinations to which gas cylinders should be delivered to customer's homes within the delivery area.

A delivery slip is prepared by a delivery manager. First, with regard to each customer, the amount of LP gas remaining in the gas cylinder is predicted based on the past gas usage, the meter indication of the gas meter of the customer's home, and the actually-delivered number. Then, the next delivery due date of gas cylinder(s) is determined. Integration is carried out for all customers within the delivery area for which the deliveryman is responsible to determine the delivery amount of gas cylinders corresponding to 2 to 10 days.

After the deliveryman exchanges the gas cylinder with the new one based on the delivery slip, the deliveryman writes, into a delivery slip, the respective items of a date of exchange, the meter indication of the exchange date, the cylinder number, and the safety inspection. When the daily delivery operation is completed, the delivery slip is submitted to the delivery manager. The delivery slip returned to the delivery manager is checked for an incomplete form by the delivery manager and is subsequently stored as data used to calculate the next delivery due date. A system has been suggested to provide an efficient delivery of gas cylinders under a system as described above (see Patent Publication 1).

As disclosed in Patent Publication 1, a system for an efficient gas cylinder delivery has been conventionally provided. However, there have been no system that can charge a gas fee based on the execution of a gas meter reading together with an unpaid gas fee for which a predetermined period has already passed since the previous charge.

Generally, it is known to charge a gas fee by a handy terminal that does not include a communication function. In this case however, it was required to check whether or not there is an unpaid gas fee by using a computer terminal other than the handy terminal to inquire of a server for the payment situation at the time. Furthermore, even when the computer terminal is used for an inquiry, the payment situation must be always updated. Therefore, if the inquiry timing does not concur with the charge timing, incorrect charge details may be issued.

### CITATION LIST

### Patent Literature

PTL 1: Japanese Patent Laid-Open No. H08-329159(1996)

### SUMMARY OF INVENTION

In view of the situation as described above, it is an objective of the present invention to provide an invoice issuing system and an invoice issuing method by which, when a gas meter reading is performed, a gas fee charge operation including the gas fee generated based on the meter reading and an unpaid gas fee can be carried out efficiently.

In order to solve the above problem, the present invention provides a gas fee invoice issuing system, comprising: a receiving unit for receiving, from a communication terminal, a request for a reading process of a gas meter as a meter reading target; a calculation unit for performing a meter reading process according to the request to calculate the gas fee for a customer in the current meter reading month; a management unit for managing the gas fee payment situation for the customer; a payment situation check unit for checking, from the payment situation managed by the management unit, the gas fee payment situation for the customer prior to the current meter reading month based on the request, and reading the unpaid gas fee from the management unit, when the gas fee is unpaid; an issuing unit for issuing invoice information including the gas fee in the current meter reading month and the unpaid gas fee; and a transmission unit for transmitting the invoice information to the communication terminal.

In order to solve the above-described problem, the present invention provides: a method of allowing a computer to issue a gas fee invoice, comprising: receiving, from a communication terminal, a request for a reading process of a gas meter as a meter reading target; performing a meter reading process according to the request to calculate the gas fee for a customer in the current meter reading month; managing the gas fee payment situation for the customer; checking, from the payment situation managed by the management unit, the gas fee payment situation for the customer prior to the current meter reading month based on the request, and reading the unpaid gas fee from the management unit, when the gas fee is unpaid; issuing invoice information including the gas fee on the current meter reading month and the unpaid gas fee; and transmitting the invoice information to the communication terminal.

According to the present invention, when a gas meter reading is carried out, a gas fee charge operation including the gas fee generated based on the meter reading and an unpaid gas fee can be carried out efficiently.

### BRIEF DESCRIPTION OF DRAWINGS

FIG. 1 is an exemplary network configuration illustrating according to one embodiment of the present invention;

FIG. 2 is a block diagram of an exemplary configuration of the delivery server of FIG. 1;

FIG. 3 illustrates an exemplary configuration of customer information stored in the storage device of the delivery server of FIG. 1;

FIG. 4A illustrates one example of information including the customer payment situation stored in the storage device of the delivery server of FIG. 1;

FIG. 4B illustrates one example of information including the customer payment situation stored in the storage device of the delivery server;

FIG. 5 is a flowchart illustrating an example of the entire operation of the delivery server according to one embodiment of the present invention;

FIG. 6 illustrates an example of indication data;

FIG. 7 is an exemplary configuration illustrating a plurality of pieces of indication data stored in the storage device of the delivery server of FIG. 1; and

FIG. 8 illustrates an example of an invoice including a gas fee bill and the meter reading details.

### DESCRIPTION OF EMBODIMENTS

The following section will describe briefly the configuration of a system in this embodiment. This system performs a gas meter reading together with charging a gas fee.

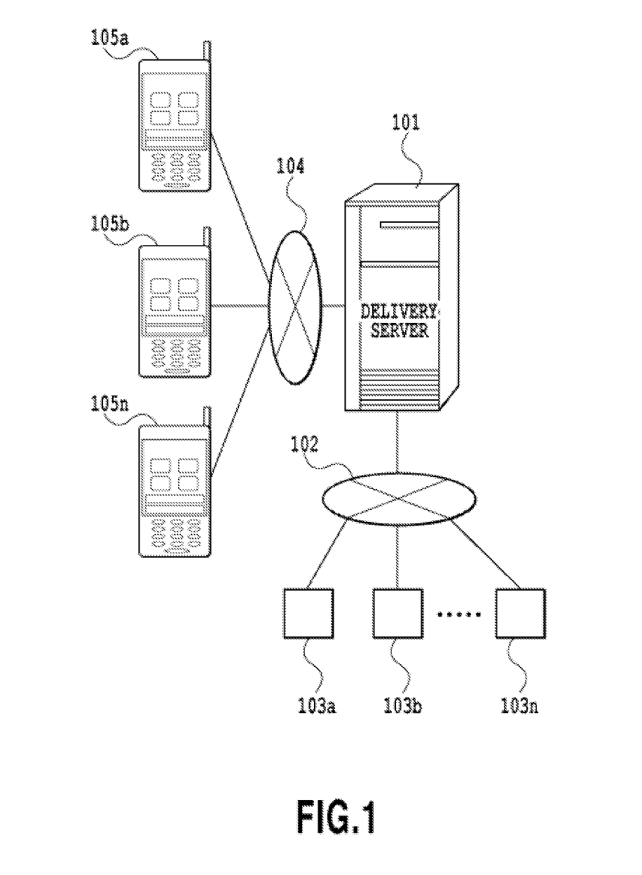

FIG. 1 illustrates a network configuration according to one embodiment of the invention. In FIG. 1, a delivery server (invoice issuing system) 101 is configured to communicate, via a network 102, with a plurality of payment computers 103a and 103b, . . . , 103n. This delivery server 101 is configured to communicate, via a network 104, with a plurality of mobile terminals (communication terminals) 105a, 105b, . . . , 105n. Hereinafter the respective plurality of payment computers 103a to 103n will be collectively referred to as a payment computer 103. Hereinafter the respective plurality of plurality of mobile terminals 105a to 105n will be collectively referred to as a mobile terminal 105.

The payment computer 103 is, for example, a computer for performing a gas fee payment for example and includes a CPU and a storage device (not shown). This payment computer 103 is connected to a delivery server 101 and notifies the delivery server 101 of the payment situation determined based on whether the payment is made or not. The payment types include, for example, payment using a bill at a convenience store or a post office, an automatic bank debit through a bank account, payment by a credit card, or an on-line electronic payment.

The mobile terminal 105 is a terminal that is used by a meter reader to confirm the meter indication of a gas meter attached to a piece of supply facility equipped with a gas cylinder and that includes, for example, CPU, memory, an input device, and a display device. The meter reader collects the indication data including the meter indication of the gas meter via the mobile terminal 105 to send the data to the delivery server 101.

### [Delivery Server Configuration]

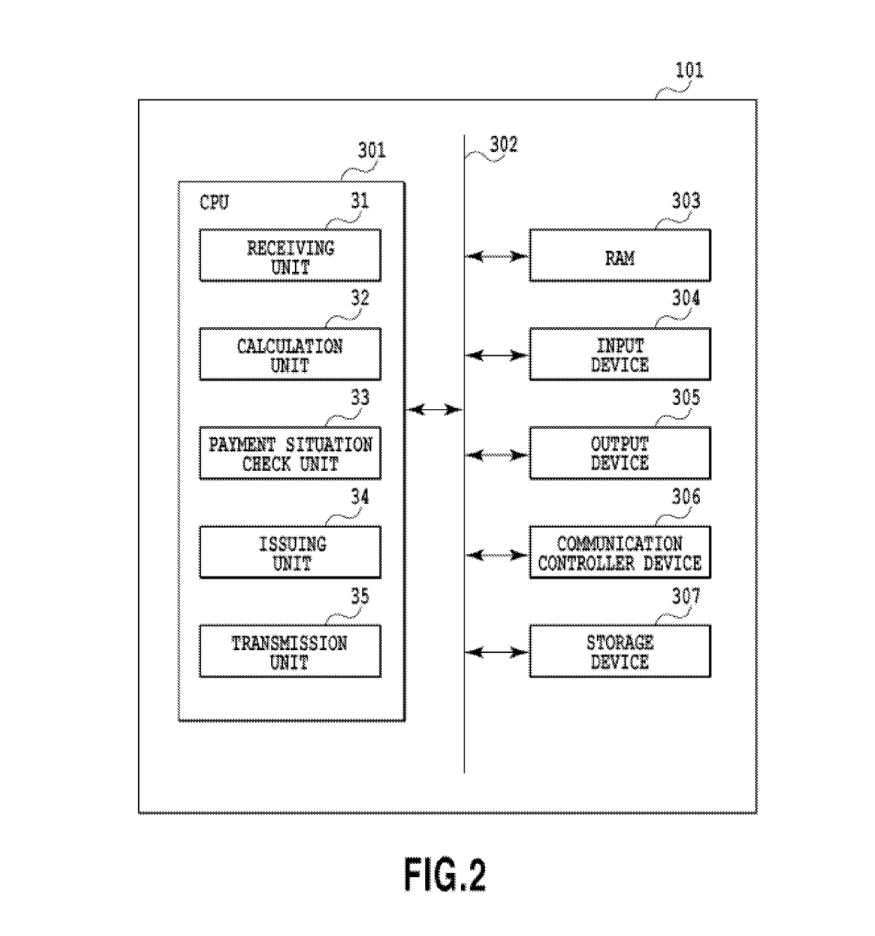

FIG. 2 is a block diagram illustrating an exemplary configuration of the delivery server 101. In FIG. 2, a case will be described in which a single computer system is used. However, there also may be a case in which the delivery server 101 is configured as a part of a multi-functional distributed system comprising a plurality of computer systems.

As shown in FIG. 2, the delivery server 101 includes a CPU 301, a system bus 302, a RAM 303, an input device 304, an output device 305, a communication controller 306, and a storage device (management unit) 307.

The CPU 301 is coupled to the respective components via the system bus 302 to perform a process to transmit a control signal or data and to execute various software programs for the operation of the entire delivery server 101 and calculation process for example.

The RAM 303 includes a work area to temporarily store data and a software program.

The storage device 307 is configured by a non-volatile storage medium such as ROM or HDD and includes a program storage area for storing a software program and a data storage area for storing data of continuously-stored data or processing result data for example. For example, a software program for example is read out from the program storage area of the storage device 307 to the work area of the RAM 303 and the software program is carried out by the CPU 301, thereby allowing the CPU 301 of this embodiment to execute the functions of the respective parts 31 to 35 (which will be described later).

The CPU 301 includes, as shown in FIG. 2, a receiving unit 31, a calculation unit 32, a payment situation check unit 33, an issuing unit 34, and a transmission unit 35.

The receiving unit 31 receives from the mobile terminal 105 a gas meter reading process request for a meter reading target. In this embodiment, the meter reading process request is performed using indication data including the meter indication showing a gas usage based on a gas cylinder and the meter reading date for example. The details of the indication data will be described later.

The calculation unit 32 performs the meter reading process according to the above-described request to calculate the gas fee of a customer based on the meter reading in the current month.

The calculation unit 32 performs the meter reading process by performing, for example, the calculation of {(the meter indication on the current meter reading date)−(the meter indication on the previous meter reading date)} to calculate the gas usage in a period from the previous meter reading date to the current meter reading date. After the calculation of the gas usage, the calculation unit 32 calculates, based on a predetermined calculating formula (e.g., (basic fee)+(unit fee)×(gas usage)), the gas fee for a customer based on the meter reading in the current month. Specifically, the gas fee for the customer based on the meter reading in the current month is, for example, the gas fee for the gas usage in a period from the previous meter reading date to the current meter reading date. The above-described method of calculating the gas fee is not limited to the above-described example and can be performed from various points of view.

The payment situation check unit 33 confirms, based on the payment situation of the storage device (management unit) 307 for managing the gas fee payment situation for the customer, the gas fee payment situation prior to the meter reading in the current month for the customer calculated by the calculation unit 32 based on the request received by the receiving unit 31. The payment situation managed by the storage device 307 will be described in detail later.

When the check by the payment situation check unit 33 shows that the gas fee is unpaid, then the payment situation check unit 33 reads the unpaid gas fee from the storage device 307.

The issuing unit 34 issues invoice information including the gas fee based on the meter reading in the current month calculated by the calculation unit 32 and the unpaid gas fee read by the payment situation check unit 33.

The transmission unit 35 transmits, to the mobile terminal 105, the invoice information issued by the issuing unit 34. The invoice information includes the gas fee based on the meter reading in the current month for example and the details thereof will be described later.

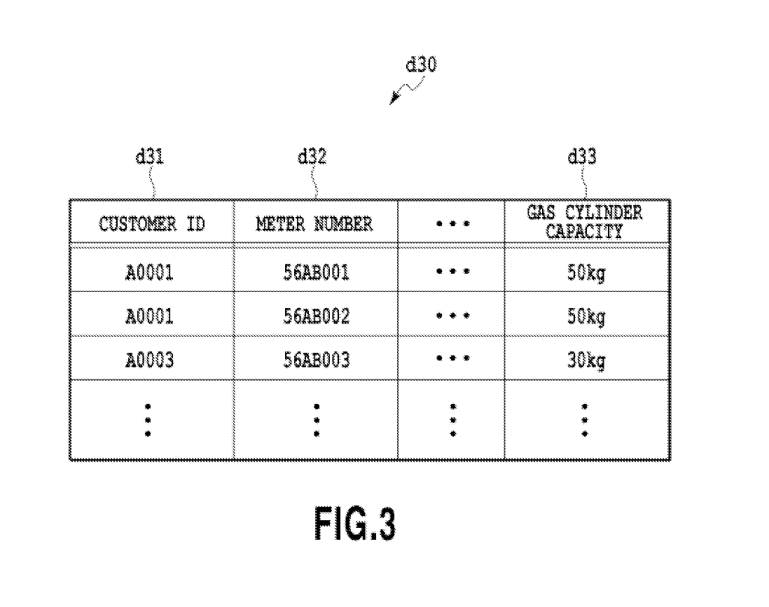

FIG. 3 illustrates an exemplary configuration of customer information d30 stored in the storage device 307 of the delivery server 101. As shown in FIG. 3, the storage device 307 stores therein a “customer ID” d31 for identifying a customer, a “meter number” d32 for identifying a gas meter, and a “gas cylinder capacity” d33 for example.

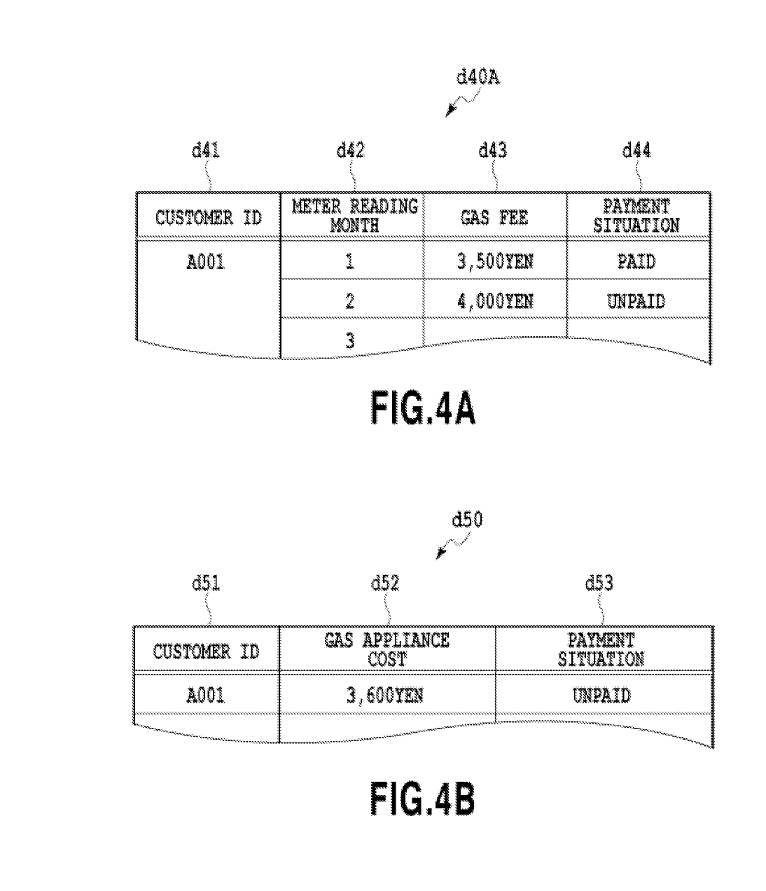

FIG. 4A and FIG. 4B illustrate an example of information including the customer payment situation stored in the storage device 307 of the delivery server 101. FIG. 4A illustrates a table storing the gas fee payment situation. FIG. 4B illustrates a table storing the gas appliance payment situation.

The table d40A of FIG. 4A includes the above-described “customer ID” d41, the “meter reading month” d42, the “gas fee” d43, and the “payment situation” d44. In one example of the table d40A of FIG. 4A, a customer identified by the customer ID “A001” is set to have “3500 yen” as a gas fee corresponding to the current month in “January” and a record is provided to show that this gas fee is already “paid”. By this configuration, whether each customer has paid each gas fee based on the meter reading in the current month is managed.

The table d50 of FIG. 4B includes the above-described “customer ID” d51, the “gas appliance cost” d52, and the “payment situation” d53. The gas appliances include, for example, a gas cooking appliance, a gas heater, and a gas fan heater.

In one example of the table of FIG. 4B, a customer having the customer ID “A001” is set to have the gas appliance cost of “3600” yen and a record is provided to show that this cost is “unpaid”. Thus, the gas appliance cost payment situation including the customer payment situation is managed.

The “payment situations” d44 and d53 in the table of FIG. 4A or FIG. 4B are set to be “paid” when the delivery server 101 receives notification from the payment computer 103. Specifically, the payment computer 103 sends to the delivery server 101, after performing the payment of the gas fee or the gas appliance cost, information for notifying the payment (e.g., the customer ID, the payment date, the meter reading month for the paid gas fee, or the gas appliance cost). As a result, the delivery server 101 changes the corresponding “payment situations” d44 and d53 in the tables d40 and d50 of FIG. 4A or FIG. 4B from “unpaid” to “paid”.

### [Operation of Delivery Server]

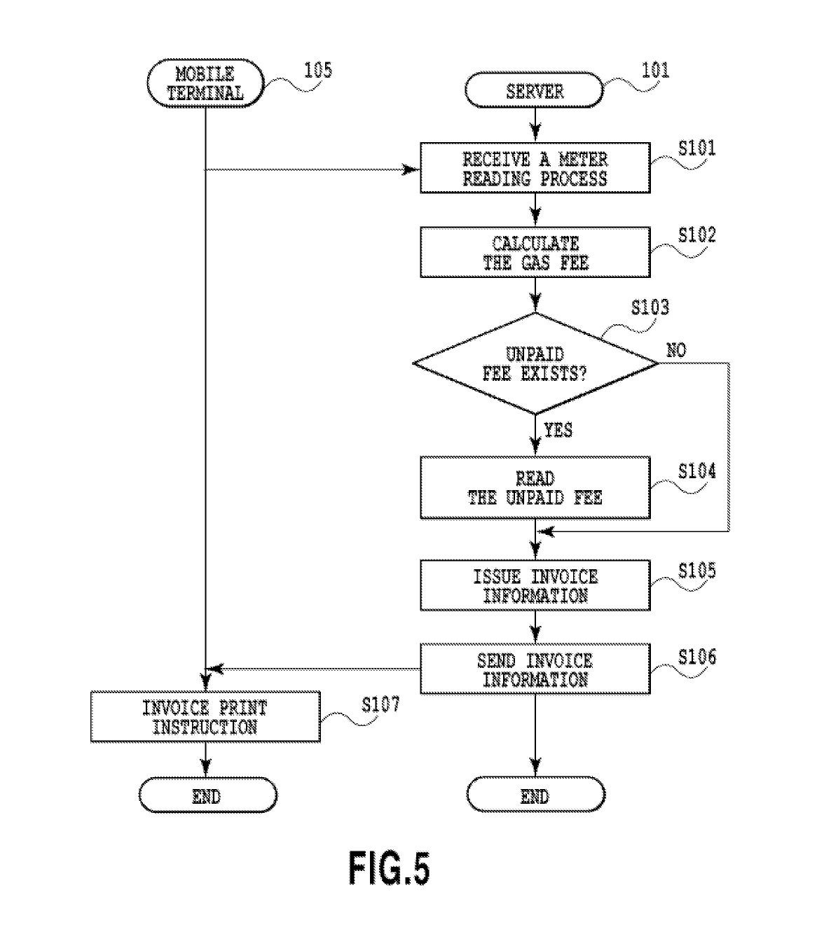

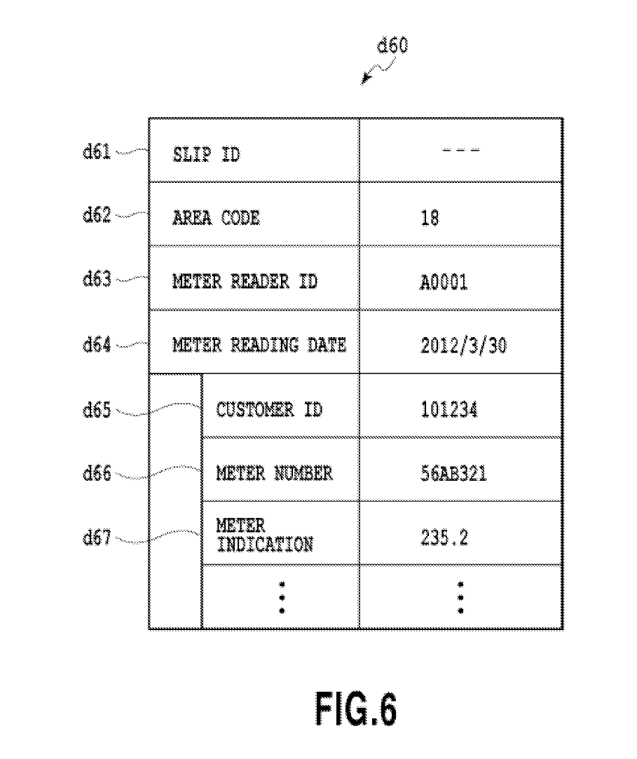

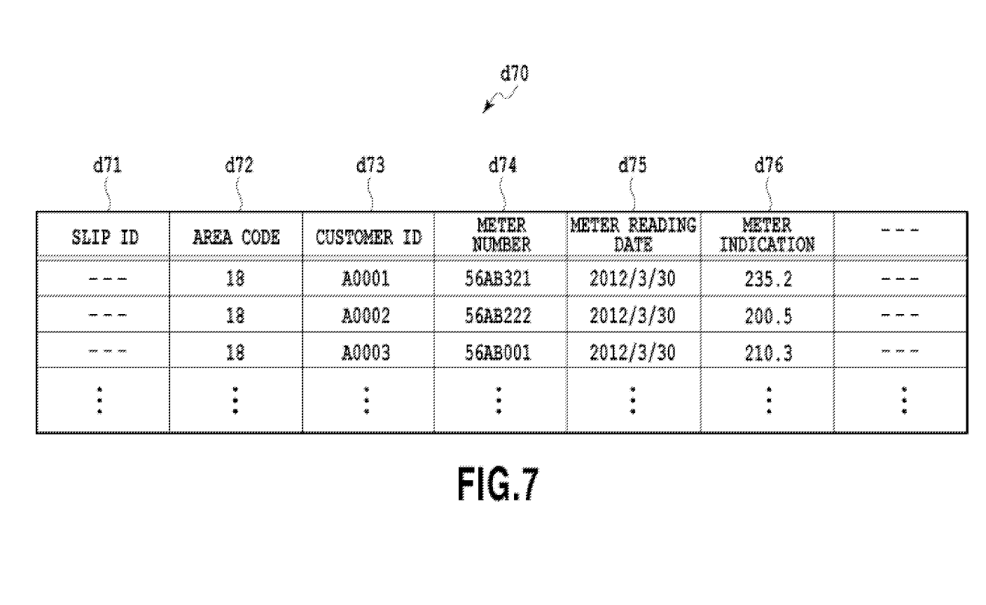

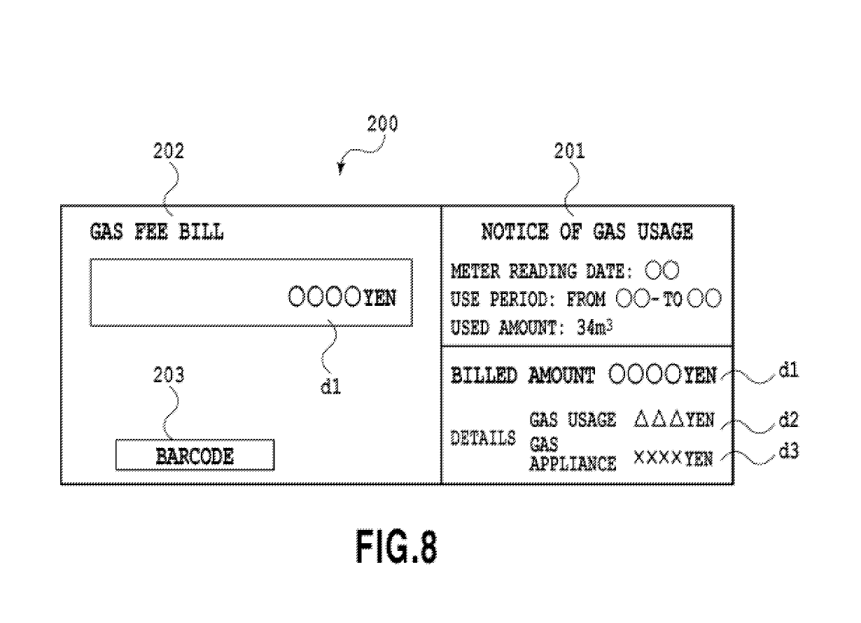

Next, the following section will describe a method of invoicing a gas fee when a gas meter reading is performed. FIG. 5 is a flowchart illustrating an example of the entire operation of the delivery server 101. FIG. 6 illustrates an example of the indication data of the gas meter. FIG. 7 illustrates an exemplary configuration of a plurality of pieces of indication data stored in the storage device 307 of the distribution server 101. FIG. 8 illustrates an example of an invoice.

In FIG. 5, when the mobile terminal 105 firstly sends a gas meter reading process request for a meter reading target to the delivery server 101. Then, the request is received by the CPU 301 (receiving unit 31) of the delivery server 101 (S101). This request is performed, as shown in FIG. 6, using indication data including a meter reading slip ID d61, an area code d62, a meter reader ID d63, a meter reading date d64, a customer ID d65, a meter number d66, and a meter indication d67 for example.

In this embodiment, the gas meter has a QR code (registered trademark) (readable information code) attached thereto. Thus, the mobile terminal 105 can read the QR code (registered trademark) to acquire the respective pieces of indication data except for the meter indication and the meter reading date. The meter indication shown in FIG. 6 is acquired based on an input operation of a meter reader for example and the meter reading date is a date on which the QR code (registered trademark) is read for example.

When the CPU 301 (receiving unit 31) of the delivery server 101 receives from the mobile terminal 105 the request using the indication data on the meter reading date, then the CPU 301 stores the indication data in the storage device 307. This exemplary storage is shown in FIG. 7. As shown in FIG. 7, the database d70 in the storage device 307 stores a plurality of pieces of indication data received by the CPU 301.

Upon receiving the above-described request, the CPU 301 (calculation unit 32) of the delivery server 101 performs a meter reading process according to the request to calculate the gas fee for the customer based on the meter reading in the current month (S102).

In this meter reading process, the gas usage is calculated based on the indication data on the current meter reading date (e.g., March 30) used in the request in S101 and the indication data used in the request received on the previous meter reading date (e.g., February 28). The storage device 307 stores the indication data on the previous meter reading date (FIG. 7). Thus, the CPU 301 reads the indication data on the previous meter reading date from the storage device 307.

The meter reading process in S102 is performed, for example, by performing {(the meter indication included in the indication data on the current meter reading date)−(the meter indication included in the indication data on the previous meter reading date)} to calculate the gas usage corresponding to a period from the previous meter reading date to the current meter reading date. Based on the gas usage, the CPU 301 calculates the gas fee for the customer based on the meter reading in the current month. In this embodiment, the gas fee for the customer based on the meter reading in the current month is set to be an amount calculated, for example, based on a formula of (basic fee)+(unit fee)×(gas usage) (e.g., 5000 yen).

Furthermore, in S103 of FIG. 5, the CPU 301 (payment situation check unit 33) of the delivery server 101 refers to the table of FIG. 4A for example to determine whether the customer has an unpaid fee or not. With reference to FIG. 4A, the customer identified by the customer ID A001 has two months worth of unpaid gas fee. Thus, this customer is determined as having an unpaid fee (“Yes” in S103). In this case, the CPU 301 reads from the table of FIG. 4A the unpaid fee corresponding to the customer ID (e.g., 4000 yen) (S104).

Furthermore, in the process to determine whether there is an unpaid fee in S103, the CPU 301 (the payment situation check unit 33) also may refer to the table of FIG. 4B for example to determine whether the customer has an unpaid fee (or an unpaid gas appliance cost) or not. With reference to FIG. 4B, the customer identified by the customer ID A001 has an unpaid gas appliance cost of 3600 yen. Thus, the CPU 301 reads the unpaid cost (e.g., 3600 yen) from the table of FIG. 4B (S104). When there is no unpaid fee in the determination in S103 (“No” in S103, then the process proceeds from S103 to S105.

Next, the CPU 301 (issuing unit 34) of the delivery server issues the invoice information including the gas fee calculated in S102 based on the meter reading in the current month (e.g., 5000 yen), and the read unpaid fee in S104 (e.g., 4000 yen). Furthermore, in this embodiment, since the gas appliance cost of 3600 yen is unpaid for example, the CPU 301 causes the invoice information to include this unpaid gas appliance cost.

Then, the CPU 301 (transmission unit 35) sends this invoice information to the mobile terminal 105 (S106).

When the mobile terminal 105 receives the above-described invoice information, the mobile terminal 105 instructs a printer (not shown) for example to print an invoice based on this information (S107). As a result, the printer 1 is caused, as illustrated in FIG. 8, to print the invoice 200 including the gas usage notice 201 showing the meter reading details and the gas fee payment slip 202. In the example of the meter reading details 201 of FIG. 8, the total billed amount d1 (=d2+d3) is printed that is obtained by adding the gas fee d1 corresponding to the gas usage (in this embodiment, the total of d1=the gas fee corresponding to the meter reading in the current month (e.g., 5000 yen)+ the unpaid gas fee corresponding to the previous month meter reading (e.g., 4000 yen)) and the unpaid gas appliance cost d2 (e.g., 5000 yen)).

In the example of the gas fee bill 202 of FIG. 8, the gas fee bill 202 includes the above-described billed amount d1 and a barcode 203 and is printed based on a format corresponding to available previously-specified payment methods (payment at a convenience store or at a post office). In this case, the previously-specified payment methods are stored in the storage device 307 to be associated with the customer ID. In the process of S105 of FIG. 5 to issue invoice information, the CPU 301 reads the payment method corresponding to the customer ID to issue invoice information including the payment method. As described above, an operation is performed to issue an invoice regarding the gas fee or the gas appliance.

As described above, during the gas meter reading, the delivery server 101 of this embodiment sends, to the mobile terminal 105, the invoice information including the current month meter reading and the unpaid gas fee. Thus, the meter reading operation and the invoicing operation can be performed simultaneously, thus achieving an efficient operation to invoice a gas fee including an unpaid gas fee.

Furthermore, since the invoice information includes an unpaid gas appliance cost also, an invoicing operation to customers can be carried out more efficiently.

As described above, an embodiment has been described. However, a specific data structure for example is not limited to the embodiment and also may be changed. For example, in S104 of FIG. 5, an example was shown in which an unpaid fee is read when such an unpaid fee exists. However, another configuration also may be used in which an unpaid fee is read only when an unpaid period is longer than a predetermined period (e.g., one week has passed since the payment deadline).

A case was described in which the invoice 200 included the meter reading details 201 and the bill 202. However, the invoice 200 may be printed in arbitrary layout, format, and contents so long as customers can be notified of the gas fee charge details generated during a gas meter reading that include the gas fee based on the meter reading in the current month and the unpaid gas fee. For example, the meter reading details 201 and the bill 202 may be printed separately so that only the bill 202 is handled as the invoice 200.

### REFERENCE SIGNS LIST

31 Receiving unit
32 Calculation unit
33 Payment situation check unit
34 Issuing unit
35 Transmission unit
101 Delivery server
105 Mobile terminal
301 CPU
307 Storage device

1. A gas fee invoice issuing system, comprising:
a receiving unit for receiving, from a communication terminal, a request for a gas meter reading process of a gas meter as a meter reading target;
a calculation unit for performing a meter reading process according to the request at the timing when the request for the gas meter reading process is received, to calculate the gas fee of a customer in the current meter reading month;
a management unit for managing the gas fee payment situation for the customer;
a payment situation check unit for checking, from the payment situation managed by the management unit, the gas fee payment situation for the customer prior to the current meter reading month based on the meter reading request for the calculation whenever the gas fee for the customer in the current meter reading month is calculated, and reading the unpaid gas fee from the management unit, when the gas fee is unpaid;
an issuing unit for issuing invoice information including the gas fee based on the current meter reading month according to the request for the gas meter reading process, and the unpaid gas fee checked when the gas fee was calculated; and
a transmission unit for transmitting, as a response to the request for the gas meter reading process, the invoice information at the time of the request to the communication terminal.

2. The invoice issuing system according to claim 1, wherein:
the management unit manages a corresponding cost payment situation of gas appliances for each of the customers, and
the issuing unit issues, when the cost for the gas appliance is unpaid at the timing when the request for the gas meter reading process is received, the invoice information at the time of the request, including the unpaid cost for the gas appliance.

3. The invoice issuing system according to claim 1, wherein: the communication terminal is configured to instruct, when receiving the invoice information, the invoice to be printed based on a previously-specified payment method.

4. A method of allowing a computer to issue a gas fee invoice, comprising:
receiving, from a communication terminal, a request for a reading process of a gas meter as a meter reading target;
performing a meter reading process according to the request at the timing when the request for the gas meter reading process is received, to calculate the gas fee of a customer in the current meter reading month;
managing the gas fee payment situation for the customer in a management unit;
checking, from the payment situation managed by the management unit, the gas fee payment situation for the customer prior to the current meter reading month based on the meter reading request for the calculation whenever the gas fee for the customer in the current meter reading month is calculated, and reading the unpaid gas fee from the management unit when the gas fee is unpaid;
issuing invoice information including the gas fee in the current meter reading month according to the request for the gas meter reading process and the unpaid gas fee checked when the gas fee was calculated; and
transmitting, as a response to the request for the gas meter reading process, the invoice information at the time of the request to the communication terminal.

5. A computer-readable storage medium storing a program to cause a computer to perform a method for issuing a gas fee invoice, the method comprising:
receiving, from a communication terminal, a request for a reading process of a gas meter as a meter reading target;
performing a meter reading process according to the request at the timing when the request for the gas meter reading process is received, to calculate the gas fee of a customer in the current meter reading month;
managing the gas fee payment situation for the customer in a management unit;
checking, from the payment situation managed by the management unit, the gas fee payment situation for the customer prior to the current meter reading month based on the meter reading request for the calculation whenever the gas fee for the customer in the current meter reading month is calculated, and reading the unpaid gas fee from the management unit when the gas fee is unpaid;
issuing invoice information including the gas fee in the current meter reading month according to the request for the gas meter reading process and the unpaid gas fee checked when the gas fee was calculated; and
transmitting, as a response to the request for the gas meter reading process, the invoice information at the time of the request to the communication terminal.
